(19) United States
(12) Patent Application Publication
(10) Pub. No.: US 2012/0173328 A1
(43) Pub. Date: Jul. 5, 2012

(54) DIGITAL ADVERTISING DATA INTERCHANGE AND METHOD

(76) Inventors: Imran RAHMAN, Miller Place, NY (US); Atlee Brown, Dix Hills, NY (US)

(21) Appl. No.: 13/342,438

(22) Filed: Jan. 3, 2012

Related U.S. Application Data
(60) Provisional application No. 61/429,306, filed on Jan. 3, 2011.

(51) Int. Cl. G06Q 30/02

(52) U.S. Cl. 705/14.47; 705/14.73

(57) ABSTRACT

An interchange enables advertising data to be interchanged among providers for serving the advertising data on different provider technology platforms and consumers for using the advertising data on different consumer technology platforms. The interchange includes provider connectors for connecting all the providers to a network, and consumer connectors for connecting all the consumers to the network. A host controller executes a standardized provider application programming interface (API) on the network to enable each provider to serve the advertising data via a respective provider connector over the network to at least one of the consumers, and for executing a standardized consumer API on the network to enable each consumer to use the advertising data via a respective consumer connector over the network from at least one of the providers.

### CROSS REFERENCE TO RELATED APPLICATION

This application claims the benefit to U.S. Provisional Patent Application Ser. No. 61/429,306, filed Jan. 3, 2011, the entire contents of which are hereby incorporated herein by reference thereto.

### FIELD OF THE DISCLOSURE

The present disclosure relates generally to a digital advertising system for, and a method of, enabling digital advertising data to be interchanged among a plurality of providers for serving the advertising data on different provider technology platforms and a plurality of consumers for using the advertising data on different consumer technology platforms.

### BACKGROUND

Innovations in internet-related technologies and their adoption over the last decade have provided advertisers an opportunity to reach their target audience in a more focused and cost-effective manner. Hence, spending in digital media advertising has grown at a phenomenal rate, and stakeholders in this digital media eco-system have found new ways of delivering, tracking and measuring digital media advertising in the form of “clicks”, “impressions”, “conversions” and “acquisitions”, etc. These stakeholders include providers for serving, selling, transacting and tracking the advertising data, and consumers for using, buying, managing and tracking the advertising data, and include advertising agencies, advertisers, marketers, ad-serving platforms, search engines, ad-networks, publishers/sites, social media, bid management platforms, etc. All of these providers and consumers are either using their own proprietary technology platforms, or some licensed third party technology platforms, to monetize and manage their share of digital media advertising.

However, no standards or standardized technology platform exists today to interconnect the providers with their individual technology platforms to the consumers with their different individual technology platforms. The promise of technological advancement and the potential transition of traditional (broadcast, print, outdoor, television, etc.) media into digital media will further increase advertising spending in this media sector, thus creating increased traffic of advertising data through these disparate and disconnected technology platforms.

Such providers and consumers will require more efficient and automated ways to reach a variety of global markets without being restricted to use one or a few technology platforms. Even in today's digital environment, timely and accurate placement of digital media campaigns, and timely and accurate reporting of advertising performance data, are of immense value. This value will grow exponentially and become quite challenging to manage as providers and consumers demand freedom from specific technology platform(s) to be able to reach their local and global target audiences in a more cost-effective fashion with the proper tracking of each advertising dollar spent.

The advertising marketplace is thus fragmented, and there are currently only individual solutions provided by individual providers/consumers. No common advertising platform or standards exist. Each consumer has to individually manage all its provider transactions and advertising data exchanges, and only a very few large consumers have either built, or are in the process of building, “one-off, partial” integrations to a few providers. These integrations tend to be customized, and costly to develop and maintain, especially when these customized integrations have to deal with disparate technology platforms. In addition, there are no standard solutions to manage the fragmented data volumes available to the consumers from the providers. Hence, there is limited consumer access to consolidated actual performance data for measurement and analysis.

Accordingly, there is a need for allowing digital advertising data interchange and interoperability regardless of technology platform in digital media advertising.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an overall diagrammatic view of a digital advertising data interchange in accordance with this invention;

FIG. 2 is a flow chart depicting how new categories are defined and created in the interchange of FIG. 1;

FIG. 3 is a flow chart depicting how providers and consumers are registered and subscribed in the interchange of FIG. 1;

FIG. 4 is a flow chart depicting the internal processing of network API calls in the interchange of FIG. 1;

FIG. 5 is a flow chart depicting how advertisers interact with various different ad agencies in the interchange of FIG. 1;

FIG. 6 is a diagrammatic view depicting a host controller for controlling operation of the interchange of FIG. 1;

FIG. 7 is a flow chart depicting how an ad agency is created and mapped in the interchange of FIG. 1; and

FIG. 8 is a flow chart depicting how an advertiser is created and mapped in the interchange of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The illustrated elements of the arrangement have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

In accordance with one feature of this invention, an interchange enables digital advertising data to be interchanged among a plurality of providers for serving the advertising data on different provider technology platforms and a plurality of consumers for using the advertising data on different consumer technology platforms. The interchange includes a network, a plurality of provider connectors for connecting all the providers with their different provider technology platforms to the network, a plurality of consumer connectors for connecting all the consumers with their different consumer technology platforms to the network, and a host controller for executing a standardized provider application programming interface (API) on the network to enable each provider to serve the advertising data via a respective provider connector over the network to at least one of the consumers, and for executing a standardized consumer API on the network to enable each consumer to use the advertising data via a respective consumer connector over the network from at least one of the providers. Thus, a standard protocol enables the digital advertising data to be interchanged over the network, regardless of the different technology platforms used.

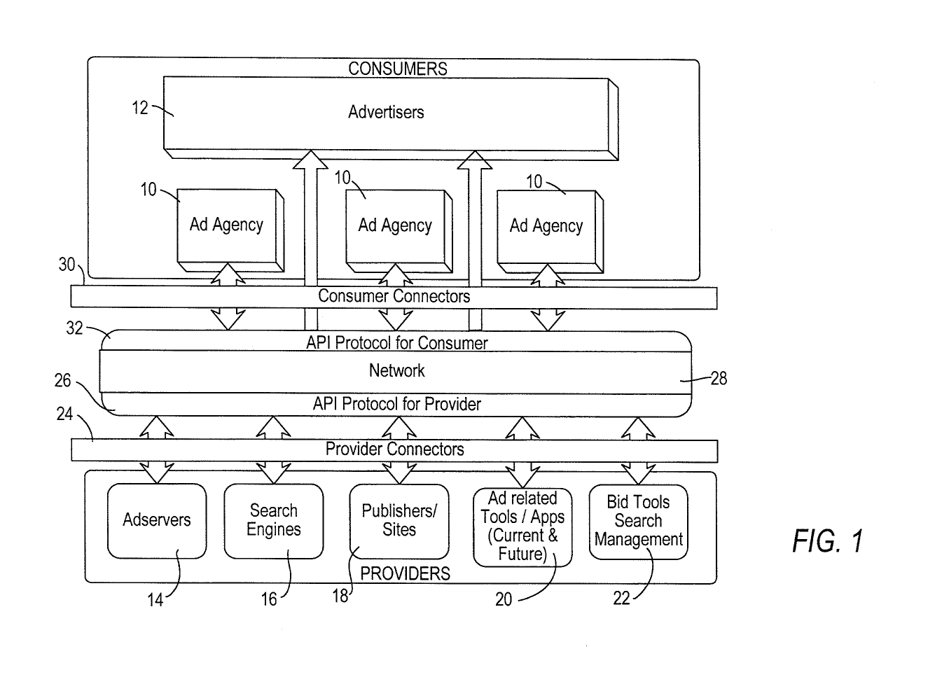

Referring to FIG. 1 of the drawings, the term “consumers” includes, but is not limited to, ad agencies 10 and advertisers 12, and the term “providers ” includes, but is not limited to, ad servers 14, search engines 16, publishers/sites 18, ad related tools 20, and bid tools/search management 22. Each of the consumers and the providers may have different technology platforms. A plurality of provider connectors 24 connect all the providers with their different provider technology platforms via a standardized provider application programming interface (API) 26 to a network 28. A plurality of consumer connectors 30 connect all the consumers with their different provider technology platforms via a standardized consumer API 32 to the network 28.

Thus, an ad agency 10 has the flexibility to use various providers (ad servers 14, bid tools 22, engines 16, etc.) to place and execute digital advertising media campaigns without being restricted to one or only a few specific providers. An advertiser 12 typically deals with one or more ad agencies 10 for various product related campaigns. A growing number of advertisers 12 are mandating each of their ad agency's use of a specific ad server 14 for their specific media campaigns, thus requiring any individual ad agency 10 to integrate multiple ad servers 14. Thus, a set of provider APIs 26 or web services specific to a single category may be provided to an ad agency 10, or to an advertiser 12, to connect that ad agency/advertiser to the network 28 to place media campaigns and/or to receive actual performance data for measurement and operational/financial management purposes. Analogously, each ad server 14, search engine 16, publisher 18, or ad/bid tool 20, 22 can receive digital media campaigns electronically from various ad agencies 10 and/or advertisers 12 for placement/trafficking purposes, and also to report actual performance data back to the ad agency 10 and/or advertiser 12.

The network 28 is a collaborative and open global network that connects all the consumers and the providers in the digital media advertising system for easy and real-time data exchange. The network 28 serves as a standard and common protocol for integrating the digital data to/from multiple and disparate technology platforms across different provider/consumer categories.

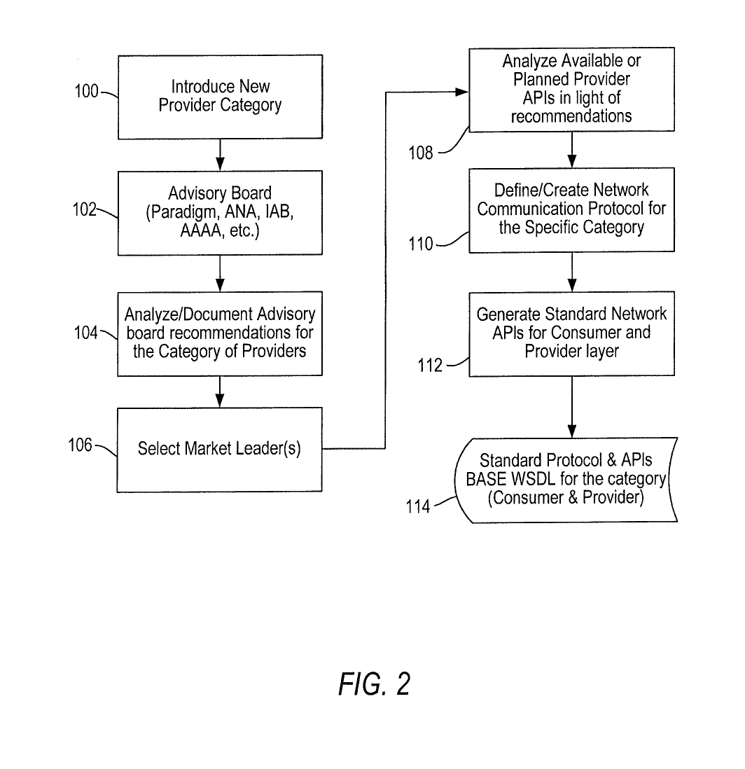

As mentioned above, the providers can advantageously be categorized by the type of tools/services provided. FIG. 2 is a flow chart depicting how such new categories are defined and created. Step 100 introduces a new provider category to an advisory board (Step 102) represented by one or more organizations and representing various stakeholders in the digital media advertising ecosystem. Based on the recommendation by the advisory board, after analysis and further document recommendations/requirements put forward by the advisory board (Step 104), a market leader(s) is then selected (Step 106) and its existing web services/API is analyzed (Step 108) to create a standard network communication protocol for a specific category (Step 110). Based on the protocol, a standard network API is generated (Step 112), and is referred to as the “BASE” API/WSDL with methods being reserved to generate extensions (Step 114) to support additional functions for future use by existing and new providers for the specific category.

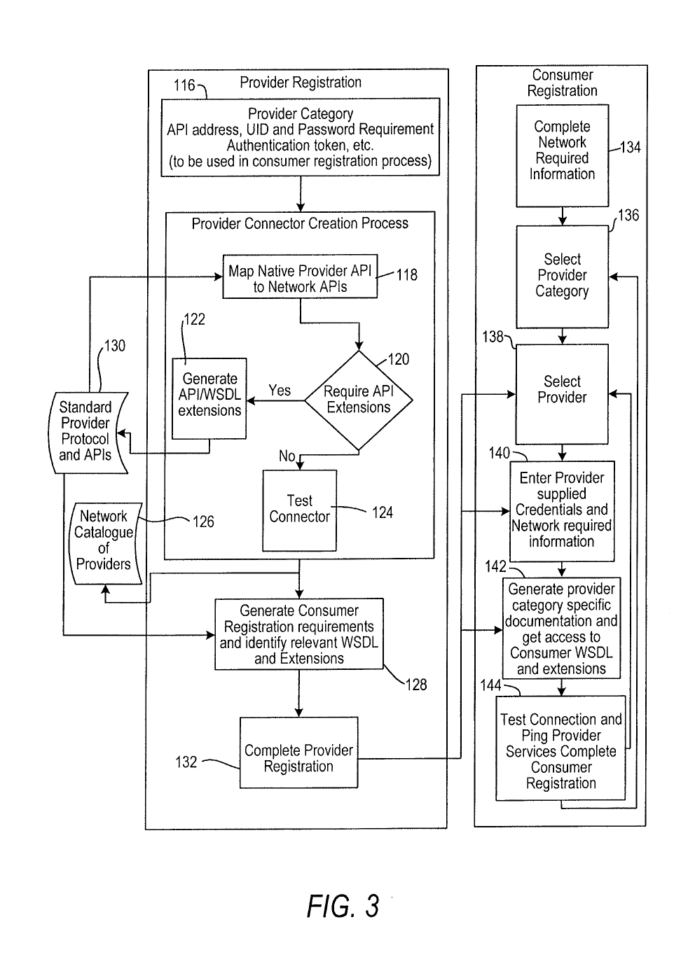

The providers and the consumers can advantageously be registered and subscribed to the network 28 as shown in FIG. 3, in which a user interface generates registration forms. The provider registration process starts with the provider completing required fields (step 116). A provider connector is created by mapping a native provider web services/API to the network standard API (step 118). An API extension (step 120) and a relevant WSDL (step 122) are then generated to support additional functions that were not previously supported. The provider connector is then tested (step 124) for connectivity and, upon successful testing, it is then added to a network database in a provider's catalogue (step 126). A consumer registration requirement is then generated (step 128) with any reference BASE APIs (step 130) and any relevant extensions WSDL(s) (step 122), if applicable. This completes the provider registration process at step 132.

The consumer registration process starts with the consumer completing required fields (step 134). A provider category is selected (step 136). A provider is selected (step 138). The selected provider's credentials are supplied (step 140). Category-specific provider documentation is generated (step 142). The customer connection is tested (step 144), thereby completing the consumer registration process at step 144.

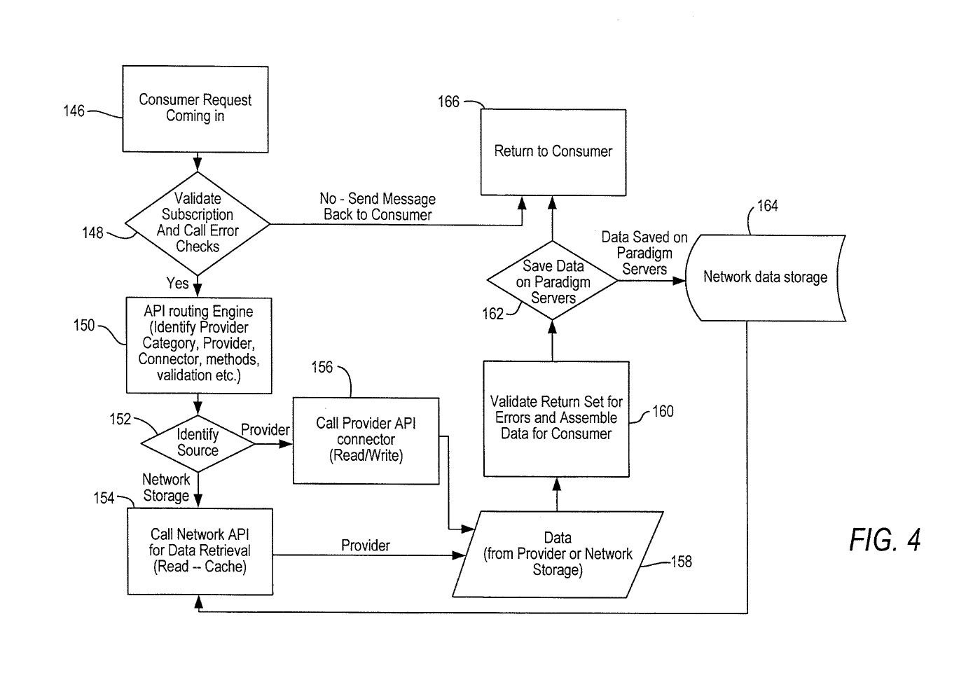

FIG. 4 is a flow chart depicting the internal processing of network API calls. An API routing engine at step 150 evaluates an incoming consumer request (step 146) and validates the subscription (step 148). If not validated (step 166), the request is returned to the consumer. If validated, the API routing engine identifies the source (step 152) and routes the request to the relevant provider API/method with appropriate mapping of parameters, and calls the relevant provider connector (step 156) and/or calls the network API (step 154) for the retrieval of stored data at step 158. Data (data set or error messages) is then assembled and validated at step 160, and saved (step 162) on the network (step 164) and/or returned to the consumer (step 166).

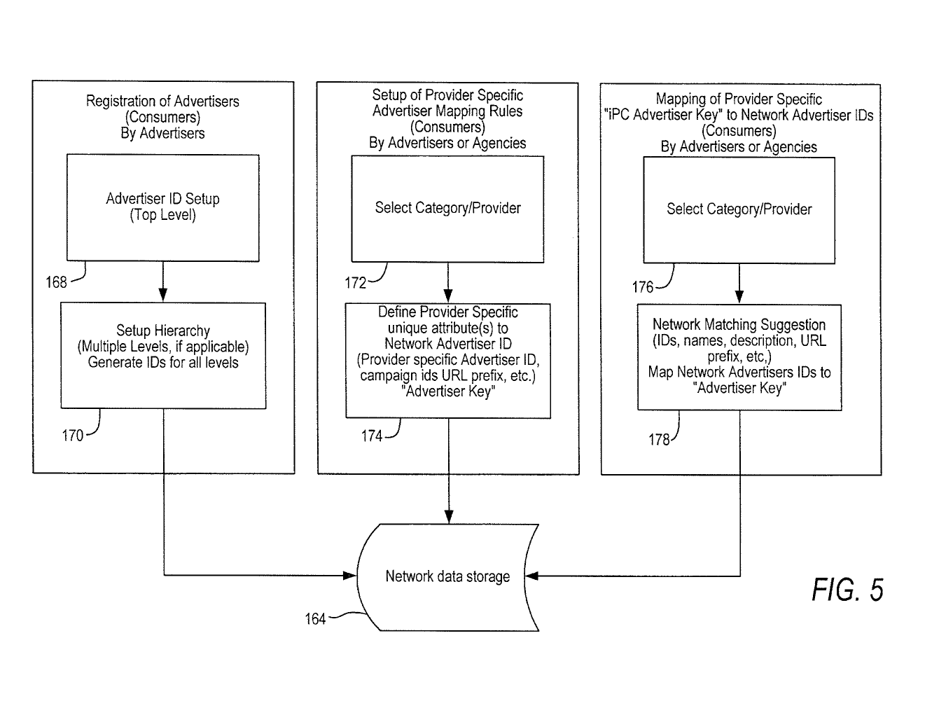

FIG. 5 is a flow chart depicting how advertisers 12 interact with various different ad agencies 10 over the network 28. Registration of an advertiser includes setting up a top level, unique advertiser identity (ID) (step 168) and a hierarchy of data elements (divisions, brands, products, etc.) to represent a desired, multiple level, hierarchy for the advertiser. The unique advertiser identities are established for every level and are stored in the network data storage 164.

Categories specific to each provider are selected in step 172 and mapped in step 176. The network is designed to track the advertisers (their brands, divisions, etc.) with every relevant API call, as well as related data that flows through the network, by relating and tracking media campaigns/placements executed through multiple channels (ad agencies, direct, etc.) and related actual performance data to an advertiser key (step 174), which in turn maps the advertiser ID of the specific level of a specific advertiser. The advertiser key is defined as a “key” field that uniquely identifies its relationship to an advertiser, and is based on linking various “sub-keys” back to advertiser registration in the network. Advertisers can be tracked (coded) differently in various provider tools, and each is normally different even in one tool that is managed by different ad agencies. For example, an agency A can have different coding for a specific advertiser and can have multiple records in a specific ad-serving tool, while agency B working with same advertiser can code multiple records for the same advertiser with a different code. This gets further complicated when there are additional tools in the same or even a different category. This invention thus allows for linking and mapping different coding across different agencies and various different provider technology platforms across various different categories of providers, thereby allowing the advertiser access to detailed and/or aggregated data sources through various disparate technology platforms. Step 178 provides key suggestions based on the intelligence gathered across various providers, and can range from tools specific to each advertiser ID, URL prefix, campaign ID prefix, etc.

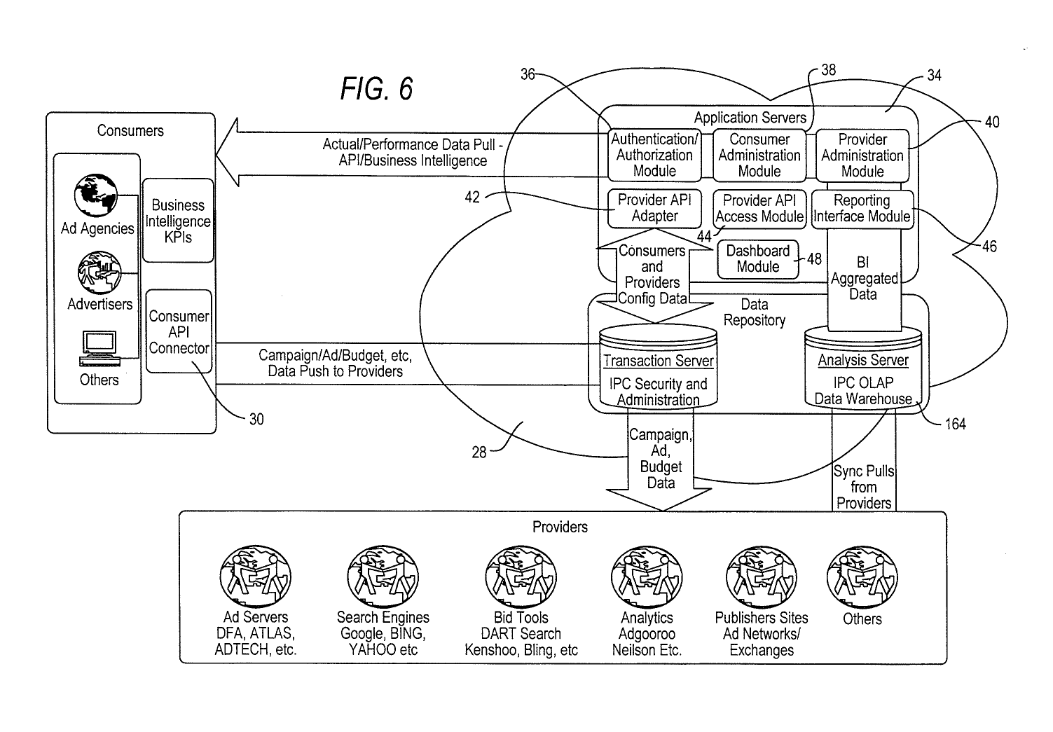

FIG. 6 depicts a host controller 34 for executing the provider and consumer API protocols, and includes a plurality of application servers or modules. An authentication/authorization module 36 provides authentication service for the consumers/providers, identifies consumer/provider subscription level for logged in consumers/providers, and enforces role-based security across the network 28. A consumer administration module 38 provides a web-based administration interface for the consumers, manages registration and maintenance of consumer accounts and individual consumer information, manages subscriptions to various providers, and maintains various subscription attributes. A provider administration module 40 provides a web-based configuration interface for various API providers, registers and maintains provider API adapter modules, and manages providers API updates, level of access, versioning and availability. A provider API adapter module 42 manages provider API authentication, data structures, and method calls specific to the provider API functionality, and implements a translation interface layer between common API calls on the network and provider specific API calls, and attaches to the provider API outside services from one side and to a provider API access module 44 from another side, and manages and maintains provider API connectivity sessions to provider API host servers, and hides complexity and maps common API data structures on the network to providers API data structures. The provider API access module 44 implements universal common API/WSDL and wraps calls to specific provider API adapters, provides periodic performance data synchronization and aggregation from specific provider data repositories, performs consumer performance data requests through an SQL analysis server query interface, and passes-through “write” data to provider API methods, such as adding/updating campaigns, ads, budget info, etc. A reporting interface module 46 provides a web-based report management interface to the consumers, provides a web-based consumer reporting building interface including report columns and selection criteria construction, filtering, sorting, grouping and formatting capabilities, and provides report run and archiving services. A dashboard module 48 provides a web-based dashboard management interface, provides a KPI matrix dashboard building blocks management interface, and provides a dashboard rendering and running service for the consumers.

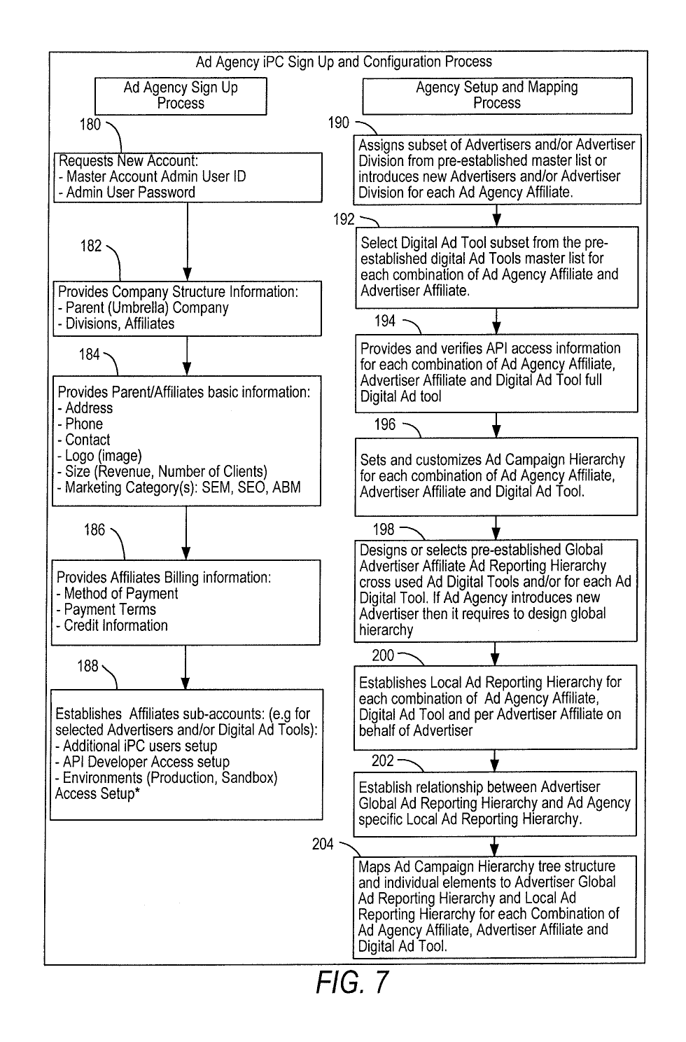

FIG. 7 is a flow chart depicting how an ad agency is signed up and configured in the interchange. At step 180, signing up of an ad agency is begun by a new account request. At step 182, company structure information is provided and, at step 184, company basic information is provided. Billing information is provided at step 186. Sub-accounts are established at step 188. The configuration of the ad agency is begun at step 190 where a subset of advertisers is assigned. At step 192, an ad tool subset is selected. At step 194, API access information is provided and verified. At step 196, a media campaign hierarchy is set up and customized. At step 198, a global reporting hierarchy is designed and selected. At step 200, a local reporting hierarchy is established. At step 202, a relationship between the global and local reporting hierarchies is established. At step 204, a campaign hierarchy structure is mapped.

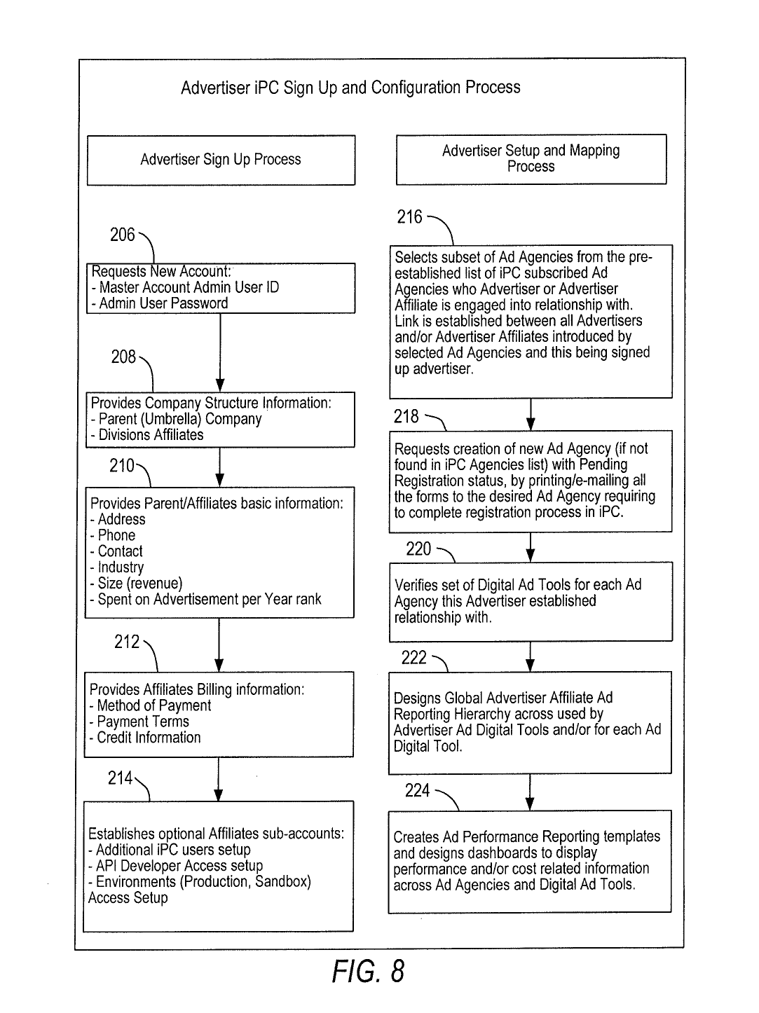

FIG. 8 is a flow chart depicting how an advertiser is signed up and configured in the interchange. At step 206, signing up of an advertiser is begun by requesting a new account. Company structure information is provided at step 208, and basic company information is provided at step 210. Billing information is provided at step 212, and sub-accounts are established at step 214. In order to configure the advertiser, a subset of ad agencies is selected from a pre-established list at step 216. A new ad agency is created upon request at step 218. Ad tools are verified at step 220. A global advertiser reporting hierarchy is designed at step 222. Reporting templates are created as well as dashboards to display performance and/or cost information at step 224.

One aspect of this invention is the capability of enabling a single advertiser the means of collecting and reporting advertising performance data across a multitude of ad tools and multiple ad agencies engaged by the single advertiser. Normally, an advertiser works with more than one ad agency, and each ad agency can use many ad tools or providers, and each tool can be defined or coded differently for each advertiser. In addition, each ad agency can register its advertisers with different coding and multiple records for each advertiser. The process of discovering, identifying, verifying and bridging the records of each advertiser is executed by the host controller which sets up a link tying together all the advertiser records representing the same advertiser. Intelligent mapping or cross referencing data from different ad tools and ad agencies to a specific advertiser is established to allow aggregation of performance data.

A consumer/provider API protocol consists of three major components: a collection of data structures, consumer connectors, and provider connectors. The collection of data structures includes value sets and operations encompassing and hiding the complexity and diversity of various provider APIs. The API provides an extensive set of reporting operations to deliver to the consumers actual performance data collected by the providers. In addition, the API consolidates operations support and aggregates performance data across a variety of ad tools based on a uniquely defined mapping interface between various provider hierarchies and required consumer reporting hierarchies. By way of example, the APIs of various providers can include data structures describing a campaign, a media plan, an advertiser, an ad group, an ad placement, a site, a keyword, and any like object. An ad tool entity hierarchy is described in an API, as set forth in the following Tables I and II.

TABLE 1

| ELEMENT | DESCRIPTION |
|---|---|
| Entity Name | Network-defined name for this entity - read-only |
| | enum value (e.g., campaign, placement, etc.) |
| ID | Unique ID attribute of entity record generated and |
| | stored within ad tool data repository |
| Name | The name attribute (can be blank for some entities) |
| | of entity record as assigned by consumer/provider |
| | during add/save operations |
| Tool ID | Underlying digital ad tool network-assigned unique |
| | ID to redirect network API call to the proper digital |
| | ad tool connector |
| Property[ ] | Array of universal self-describing property objects |
| | that define each individual campaign attribute |
| | specific for this tool ID |

TABLE 2

| ELEMENT | DESCRIPTION |
|---|---|
| Name | Entity attribute name as defined by provider API |
| Data Type | Data type of this attribute, string, integer, double and |
| | arrays of strings, integers, doubles are supported |
| Value | Attribute value for single-valued attributes |
| ValueList[ ] | Attribute value for multi-valued attributes |
| ValueSet | Full value set as defined by provider API for enum |
| | attributes |
| IsRequired | Is attribute required |
| Blanket Value | Default value assigned by CreateBlanketEntity |
| | operation |
| Description | Description of the entity attribute as described in |
| | provider API reference documentation |

Every specific entity must be created first before using it in consequent operations as follows:

Entity=CreateBlanketEntity(String entityName, DigitalTool digitalTool),

where entityName is one of the provider APIs underlying the entity names defined specifically for each digital tool. The creation of a blanket entity allows proper initialization of particular entity objects specific to the provider API.

Consumers/providers of the API can always get a list of defined entity names using one of the API helper methods such as:
String[ ] GetEntityNames(DigitalTool digitalTool).
   Further down, after setting up all the necessary attributes, an entity object can be used in various API operations as follows:

AddEntity(Entity e)

DeleteEntity(Entity e)

UpdateEntity(Entity e)

All fetch operations require an additional universal parameter Entity Search Filter list, as follows:
Entity[ ] GetEntityList(EntitySearchFilter[ ] esf)
Entity Search Filter can be defined and initialized in a similar fashion as an Entity object:
EntitySearchFilter=CreateBlanketEntitySearchFilter(String entityName, DigitalTool digitalTool)

It is required sometimes to get all equivalent entities such as, for example, advertisement campaigns defined across multiple digital ad tools falling into different digital ad tool categories. For example, one might ask for all campaigns defined in Google DFA (Ad Server category), Microsoft Atlas (Ad Server category), Google AdWords (Search Engine category), Microsoft AdCenter (Search Engine category). The network API will provide such a list based on the specific search filter criteria, but interpreting this list is up to the consumer/provider. As an example: an ad server campaign carries start and end dates, but a search engine campaign does not have these attributes.

Structuring a network API in this way allows maximum flexibility and total independence from the underlying provider APIs and provides an extremely stable WSDL web service interface capable of withstanding inevitable provider API upgrades without refreshing API client proxies.

Consumer connectors are implemented as a set of client libraries (or wrappers) for various programming languages (.NET C#, .NET VB, Java, Perl, Python) making it easier to quickly develop applications in a desired language and hiding API generalities and complexities like SOAP messaging, authentication, error handling, name/value types of data structures, data retrieval and parsing. The consumers connectors are also capable of translating the generic nature of the API to the specifics of particular provider data structures and value sets and geared toward subscribers that prefer a different style of API usage where each provider entity's hierarchy is explicitly defined. For example, a Google DFA consumer connector will define objects such as advertiser, campaign, placement, site, etc. The convenience and simplicity of using these libraries allows developers to implement their projects faster in some situations, especially when multiple digital tools are not required.

Provider connectors are implemented internally by an API as a translation layer between each provider native API protocol to its respective advertising data and a standard API protocol.

In accordance with another feature of this invention, a method of enabling advertising data to be interchanged among a plurality of providers for serving the advertising data on different provider technology platforms and a plurality of consumers for using the advertising data on different consumer technology platforms, is performed by connecting all the providers with their different provider technology platforms to a network, connecting all the consumers with their different consumer technology platforms to the network, and executing a standardized provider application programming interface (API) on the network to enable each provider to serve the advertising data over the network to at least one of the consumers, and executing a standardized consumer API on the network to enable each consumer to use the advertising data over the network from at least one of the providers, thereby enabling the advertising data to be interchanged over the network.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An interchange for enabling advertising data to be interchanged among a plurality of providers for serving the advertising data on different provider technology platforms and a plurality of consumers for using the advertising data on different consumer technology platforms, the interchange comprising:
a network;
a plurality of provider connectors for connecting all the providers with their different provider technology platforms to the network;
a plurality of consumer connectors for connecting all the consumers with their different consumer technology platforms to the network; and
a host controller for executing a standardized provider application programming interface (API) on the network to enable each provider to serve the advertising data via a respective provider connector over the network to at least one of the consumers, and for executing a standardized consumer API on the network to enable each consumer to use the advertising data via a respective consumer connector over the network from at least one of the providers, thereby enabling the advertising data to be interchanged over the network.

2. The interchange of claim 1, wherein the host controller includes an authentication module for authenticating the providers and the consumers.

3. The interchange of claim 1, wherein the host controller includes an administration module for administering the providers and the consumers.

4. The interchange of claim 3, wherein the administration module is operative for grouping the providers into specific categories.

5. The interchange of claim 4, wherein the administration module is operative for mapping at least one of the consumers with multiple providers in a specific one of the categories, and wherein the host controller is operative for tracking and aggregating the data interchange for all the multiple providers in the specific one category.

6. The interchange of claim 5, wherein the administration module is operative for assigning to the at least one consumer an identifying key to be shared by all the multiple providers in the specific one category.

7. The interchange of claim 5, wherein the host controller includes a reporting module for reporting transactional information about the tracked and aggregated data to the at least one consumer.

8. A method of enabling advertising data to be interchanged among a plurality of providers for serving the advertising data on different provider technology platforms and a plurality of consumers for using the advertising data on different consumer technology platforms, the method comprising:
connecting all the providers with their different provider technology platforms to a network;
connecting all the consumers with their different consumer technology platforms to the network; and
executing a standardized provider application programming interface (API) on the network to enable each provider to serve the advertising data over the network to at least one of the consumers, and executing a standardized consumer API on the network to enable each consumer to use the advertising data over the network from at least one of the providers, thereby enabling the advertising data to be interchanged over the network.

9. The method of claim 8, and further comprising authenticating the providers and the consumers.

10. The method of claim 8, and further comprising administering the providers and the consumers.

11. The method of claim 10, wherein the administering is performed by grouping the providers into specific categories.

12. The method of claim 11, wherein the administering is performed by mapping at least one of the consumers with multiple providers in a specific one of the categories, and further comprising tracking and aggregating the data interchange for all the multiple providers in the specific one category.

13. The method of claim 12, wherein the mapping is performed by assigning to the at least one consumer an identifying key to be shared by all the multiple providers in the specific one category.

14. The method of claim 12, and further comprising reporting transactional information about the tracked and aggregated data to the at least one consumer.
